(19) United States
(12) Patent Application Publication
(10) Pub. No.: US 2007/0138078 A1
(43) Pub. Date: Jun. 21, 2007

(54) Spin-on filter and methods

(75) Inventor: Reynold Frederick Durre, Stevens Point, WI (US)

Correspondence Address: MERCHANT & GOULD PC, P.O. BOX 2903, MINNEAPOLIS, MN, 55402-0903, US

(73) Assignee: Donaldson Company, Inc.

(21) Appl. No.: 11/642,379

(22) Filed: Dec. 19, 2006

Related U.S. Application Data
(60) Provisional application No. 60/752,327, filed on Dec. 20, 2005.

(51) Int. Cl. B01D 27/08

(52) U.S. Cl. 210/232; 210/440; 210/450

(57) ABSTRACT

A fluid filter assembly includes a housing having a wall defining an interior, a closed end, and an open end. A filter element is operably oriented in the interior of the housing. A baffle plate is mounted to operably cover the housing open end. The baffle plate includes a first axial face with an exterior top end surface and an outer circumferential wall circumscribing the first axial face. The outer circumferential wall is groove-free and forms an outer radial surface. The outer circumferential wall has a first diameter portion adjacent to the first axial face and a second diameter portion. The second diameter portion is remote from the first axial face. The second diameter portion has a diameter less than the first diameter portion. A seal is located between the housing and the baffle plate resulting from an interference fit between the housing wall and the second diameter portion. A filter arrangement includes the filter assembly operably removably mounted to a filter head. Methods for construction include creating an interference fit between the baffle plate and the housing. Methods of installing include spinning a filter assembly onto a filter head.

This application is a non-provisional of U.S. provisional application 60/752,327 filed Dec. 20, 2005. Priority is claimed under 35 U.S.C. §119(e) to provisional application 60/752,327. The complete disclosure of application 60/752,327 is incorporated by reference herein in its entirety.

### TECHNICAL FIELD

This disclosure concerns generally a fluid filter. In particular, this disclosure relates to a filter incorporating an improved seal arrangement, methods of assembly, methods of servicing, and methods of use.

### BACKGROUND

Filters have been employed in a variety of applications including hydraulic systems and engine lubrication and fuel systems. Such filter assemblies generally include a cylindrical filter element within a can or housing with a baffle or attachment plate at one end to connect the filter to a filter head, typically by a threaded joint. A central opening and several surrounding openings in the baffle direct flow through the filter and, in particular, the filter element. The flow can be in either a forward flow direction or in a reverse flow direction. A circular gasket serves as a seal between the baffle and the can or housing.

Various models and designs of filters have been known over the years. Many designs improve on various aspects of these filters. Continued improvements in filters are desired.

### SUMMARY OF THE DISCLOSURE

A fluid filter assembly is provided including a housing having a wall defining an interior, a closed end, and an open end. A filter element is operably oriented in the interior of the housing. A baffle plate is mounted to operably cover the housing open end. The baffle plate includes a first axial face with an exterior top end surface and an outer circumferential wall circumscribing the first axial face. The outer circumferential wall is groove-free and forms an outer radial surface. The outer circumferential wall has a first diameter portion adjacent to the first axial face and a second diameter portion. The second diameter portion is remote from the first axial face. The second diameter portion has a diameter less than the first diameter portion. A seal is located between the housing and the baffle plate resulting from an interference fit between the housing wall and the second diameter portion.

In another aspect, a filter arrangement is provided including a fluid filter assembly, as characterized above, and a filter head. The filter assembly is operably removably mounted on the filter head.

In another aspect, a method for constructing a fluid filter is provided. The method includes providing a housing having a closed end and an open end. Next, there is a step of mounting a filter element and a baffle plate assembly into the housing through the open end. The filter element and baffle plate assembly includes a baffle plate having an outer circumferential wall with a first diameter portion and a second diameter portion. The second diameter portion has a diameter less than the first diameter portion. Next, there is a step of pressing the baffle plate into the housing to create an interference fit between the second diameter portion and the housing. Next, there is a step of folding a portion of the housing over a top of the baffle plate.

In another aspect, a method of installing a filter assembly is provided. The method includes spinning a filter assembly onto a filter head. The filter head is mounted on and in fluid communication with a fluid system of equipment. The filter assembly includes the features as characterized above.

### BRIEF DESCRIPTION OF THE DRAWINGS

FIG. 1 is a perspective view of one embodiment of a fluid filter assembly constructed according to principles of this disclosure;

FIG. 2 is a cross-sectional view of the fluid filter assembly of FIG. 1, the cross-section being taken along the line 2-2 of FIG. 8;

FIG. 3 is an enlarged, fragmented view of a portion of the fluid filter assembly depicted in FIG. 2;

FIG. 4 is a cross-sectional view of a baffle plate used in the fluid filter assembly of FIGS. 1-3;

FIG. 5 is an enlarged view of a portion of the baffle plate depicted in FIG. 4;

FIG. 6 is a cross-sectional view of a filter housing utilized with the fluid filter assembly of FIGS. 1-3;

FIG. 7 is an enlarged, fragmented view of a portion of the filter housing depicted in FIG. 6;

FIG. 8 is a schematic, side elevational view of a filter arrangement including the filter assembly depicted in FIGS. 1 and 2 connected to a filter head; and

FIG. 9 is a fragmented, cross-sectional view of a prior art fluid filter assembly.

### DETAILED DESCRIPTION

A. Overall Assembly Systems of Use

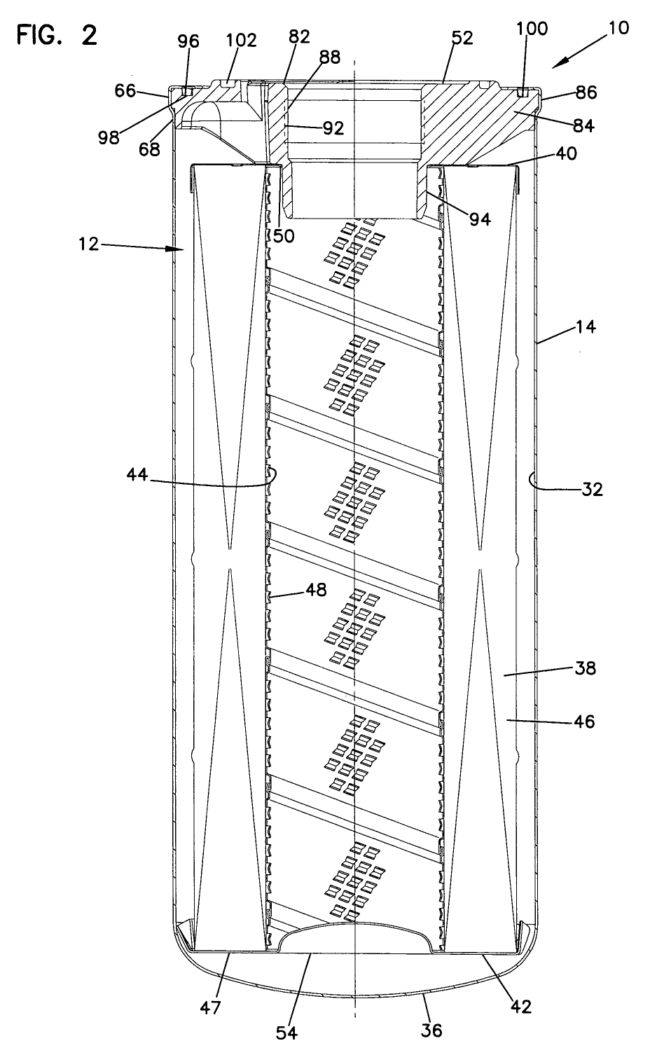

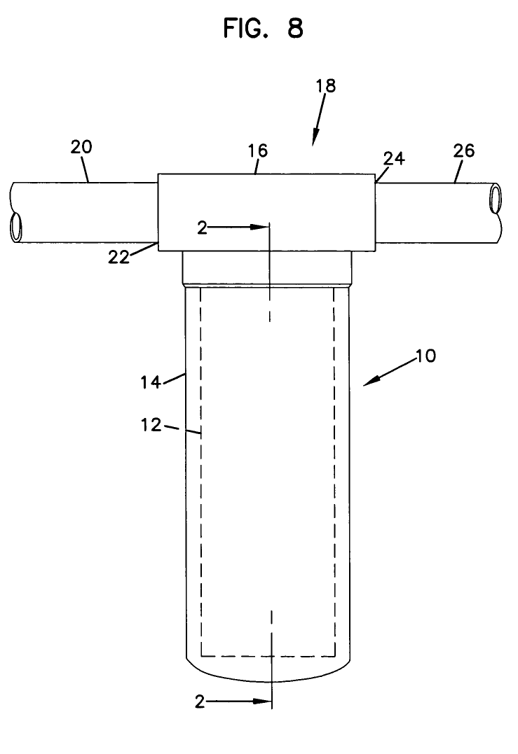

Referring to FIG. 8, there is illustrated a fluid filter assembly 10. Filter assembly 10 is particularly adapted for filtration of liquid, for example oil, or for example, in a hydrostatic transmission or other hydraulic system. The first assembly 10 includes a filter cartridge or element 12 (FIG. 2) operably oriented in a can or housing 14. The filter assembly 10 is operably mounted to a filter block or filter head 16, typically by screwing the filter assembly 10 onto the filter head 16 by internal threads on the filter assembly 10.

The filter assembly 10 is utilized in a filtering system 18. The filtering system 18 includes a supply 20 for supplying dirty fluid to the filter assembly 10 through an inlet 22 of the filter head 16. The fluid enters and is filtered or cleaned by the filter element 12. The clean fluid exits the filter head 16 at an outlet 24 and is carried away by pipe 26.

One application for the filter assembly 10 is to remove particulate matter from hydraulic fluid that is used in a vehicle. For example, the vehicle could be a tractor. The tractor may have a hydrostatic transmission and a hydraulic system, both of which require a filter. The hydraulic system can be used for a variety of purposes including raising and lowering farm implements, such as plows. A hydraulic system can also be used to raise and lower earth moving equipment, such as blades, buckets, backhoes, and scrapers. Other applications for the filter assembly 10 include other farm equipment, construction equipment, skidders, loaders, off-road vehicles, over the highway trucks, automobiles, industrial machines, and other devices that require the filtering of fluids. Additionally, the filter assembly 10 can be used to remove foreign matter from a variety of different fluids. Examples of liquid fluids include other hydraulic fluids, engine lubrication oil, diesel fuel, gasoline, engine coolant, automatic transmission fluid, and others.

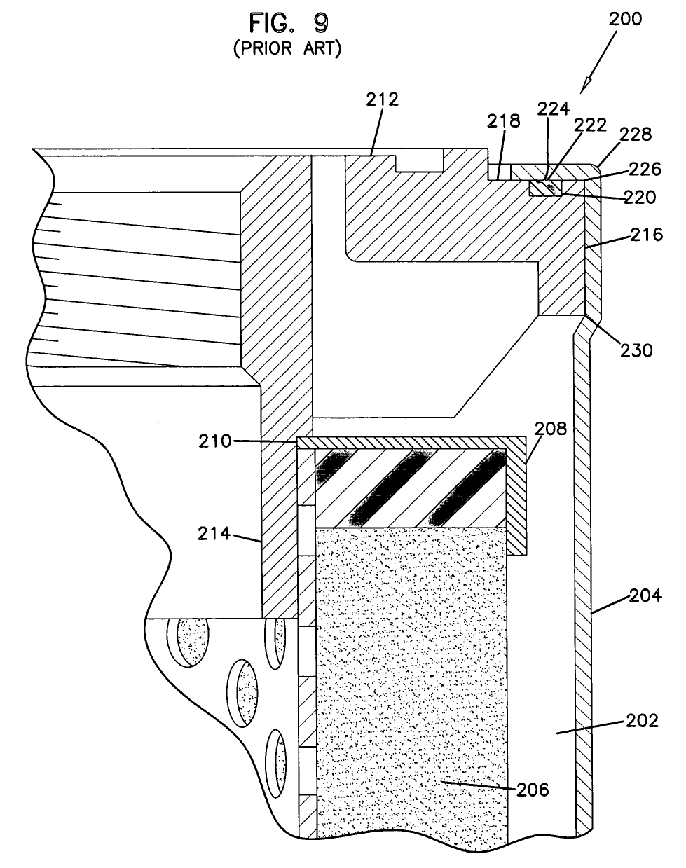

B. Some Problems with Existing Filter Assemblies, FIG. 9

Attention is next directed to FIG. 9, which depicts a portion of a prior art filter assembly 200. In the filter assembly 200, there is a filter element 202 held within an outer can or housing 204. The filter element 202 includes filter media 206 secured to or potted within an end cap 208. The end cap 208 includes an opening 210, which circumscribes a portion of a baffle plate 212. The baffle plate 212 is secured across an open end of the housing 204. The baffle plate 212 has a central hub 214 which is circumscribed by the opening 210 in the end cap 208.

The baffle plate 212 has an outer radial surface 216. The outer radial surface 216 is groove-free.

The baffle plate 212 defines a first axial face 218 and defines a sealing groove 220. A sealing gasket 222 is oriented within the groove 220. The gasket 222 forms a seal 224 between the housing 204 and the baffle plate 212.

The prior art filter assembly 200 can introduce certain problems. For example, the baffle plate 212 has a corner 226 at a top edge of the outer radial surface 216. That is, the corner 226 is the intersection of the outer radial surface 216 and the top face 218 of the baffle plate 212. During assembly, if the baffle plate 212 is dropped, banged up, pranged or otherwise dinged, it can result in nicks or dents in the corner 226. Nicks or dents in the corner 226 can allow pressure to bypass the metal to metal contact between the baffle plate 212 and the can 204. This pressure can result in failure at the top bend 228 in the can 204. When there are no dents, prangs, dings, or other imperfections in the baffle plate 212, a metal to metal seal between the baffle plate 212 and the can 204 at both the lower corner 230 and the upper corner 226 keeps the pressure from traveling along the region between the outer radial surface 216 and the inner surface of the can 204.

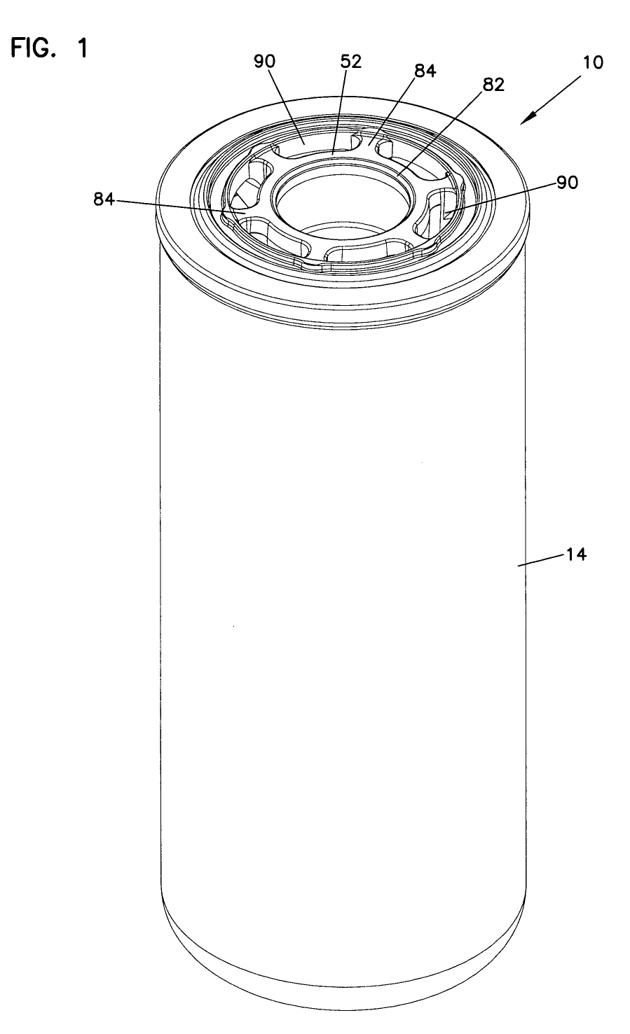

C. Improved Filter Assembly 10, FIGS. 1-8

The filter assembly 10 of FIGS. 1-8 was designed to address problems of the prior art filter assembly 200 of FIG. 9. For example, it was recognized that if the baffle plate has a reduced diameter portion that is sized to create an interference fit with the housing, the reduced diameter portion will be protected from dings and nicks. The interference fit will create a metal to metal seal between the can wall and the baffle plate. This metal to metal seal prevents pressure from traveling along the outer radial surface of the baffle plate so there is not failure at the bend of the can wall. Details of this improved filter assembly 10 are discussed below.

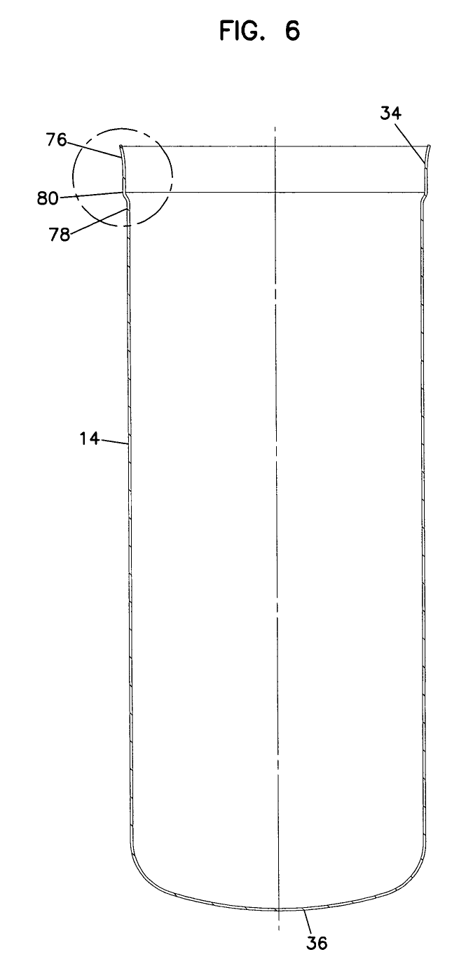

In reference now to FIG. 2, the filter assembly 10 includes the filter element 12 operably oriented within the housing 14. The housing 14 has an interior volume 32 designed to accept the filter element 12 therein. The filter housing 14 generally has a first open end 34 (FIG. 6) and a closed second end 36. Preferably, the housing 14 is of a generally thin-walled construction having sufficient rigidity to withstand the pressure experienced during typical filtering operations. Housing 14 is typically metal, plastic, or other suitable material; if housing 14 is metal, it is typically formed by stamping or drawing from the metal.

The filter element 12 is located inside the interior volume 32. The filter element 12 includes a filtering material 38 for removing contaminants, such as particulate, from the fluid being filtered. Filtering material 38 extends from, and is potted within, a first end cap 40 and a second end cap 42. Filtering material 38 defines an open interior volume 44. Typically, the filtering material 38 is material such as cellulose, paper, non-woven material, synthetic material and the like. The filter material 38 may be treated or coated to improve its filtering capabilities.

In the one shown, the filter material 38 includes filter media 46 that is generally a pleated, porous material, such as paper. A perforated tubular inner liner 48 is surrounded by an extension of filter media 46 and typically extends between the first and second end caps 40, 42.

The first end cap 40 is an open end cap and includes an opening 50 therein. The opening 50 receives, circumscribes, and surrounds a portion of a baffle plate 52. The baffle plate 52 is secured across the open end 34 of the housing. The second end cap 42 is a closed end cap 42 that extends across and covers the end 47 of the filtering material 38 such that there cannot be access to the open interior volume 44 at end 54 of the filter element 12.

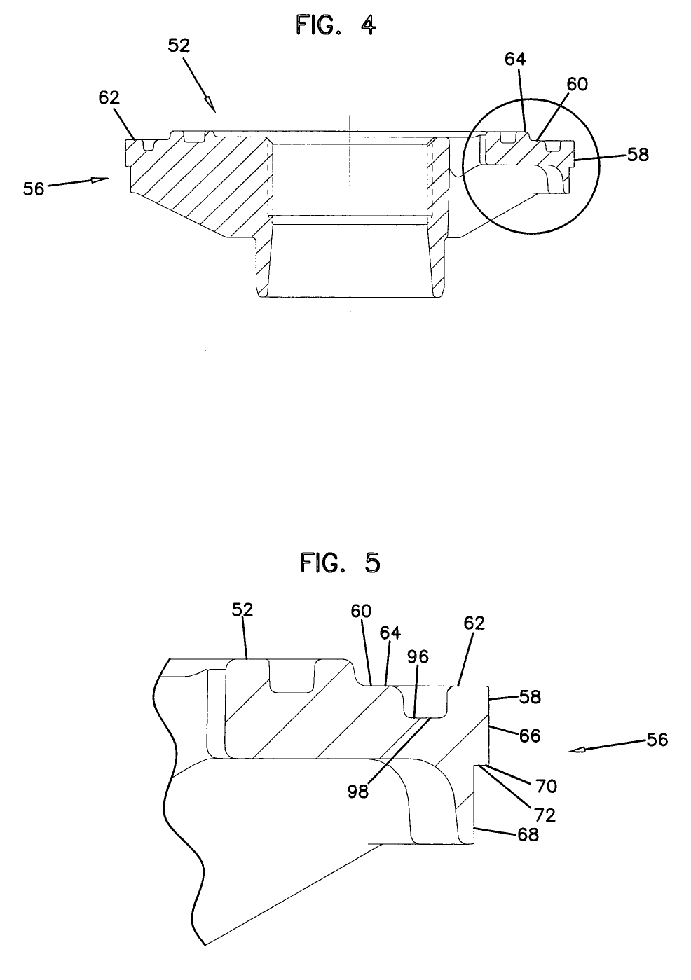

In reference now to FIG. 4, the baffle plate 52 conveys filtered liquid from the filter assembly 10 and provides a barrier that prevents the bypass of unfiltered liquid around the filtering material 38. The baffle plate 52 includes an outer radial surface 56 that forms an outer circumferential wall 58 of the baffle plate 52. The baffle plate 52 includes a first axial face 60, which corresponds to a top end surface 62. The top end surface 62 corresponds to a top face 64. The face 64 is generally in a plane that is orthogonal to the outer wall 58.

In reference now to FIGS. 2-5, in particular, FIG. 5, the outer wall 58 of the baffle plate 52 includes at least a first diameter portion 66 and a second diameter portion 68. In the embodiment shown, the second diameter portion 68 is remote from the first axial face 60. In the specific embodiment depicted in FIG. 5, the radial surface 56 includes only first diameter portion 66 and second diameter portion 68, with the first diameter portion 66 being located between the first axial face 60 and the second diameter portion 68. In the embodiment shown, the first diameter portion 66 is immediately adjacent to and perpendicular to the first axial face 60. In the embodiment shown, the second diameter portion 68 has a diameter less than the first diameter portion 66. Because of this difference between the first diameter portion 66 and the second diameter portion 68, a step 70 is formed at the interface between the first diameter portion 66 and second diameter portion 68. In the embodiment shown, the step 70 is abrupt; that is, a ledge is formed defining an axial surface 72 that is parallel to the first axial face 60 and perpendicular to the first diameter portion 66 and second diameter portion 68.

In the embodiment shown, the difference in the first diameter portion 66 and the second diameter portion 68 is at least 1.5%, preferably, at least 2%. The difference between the first diameter portion 66 and the second diameter portion 68 is not greater than 5%. Some specific examples are discussed more fully below.

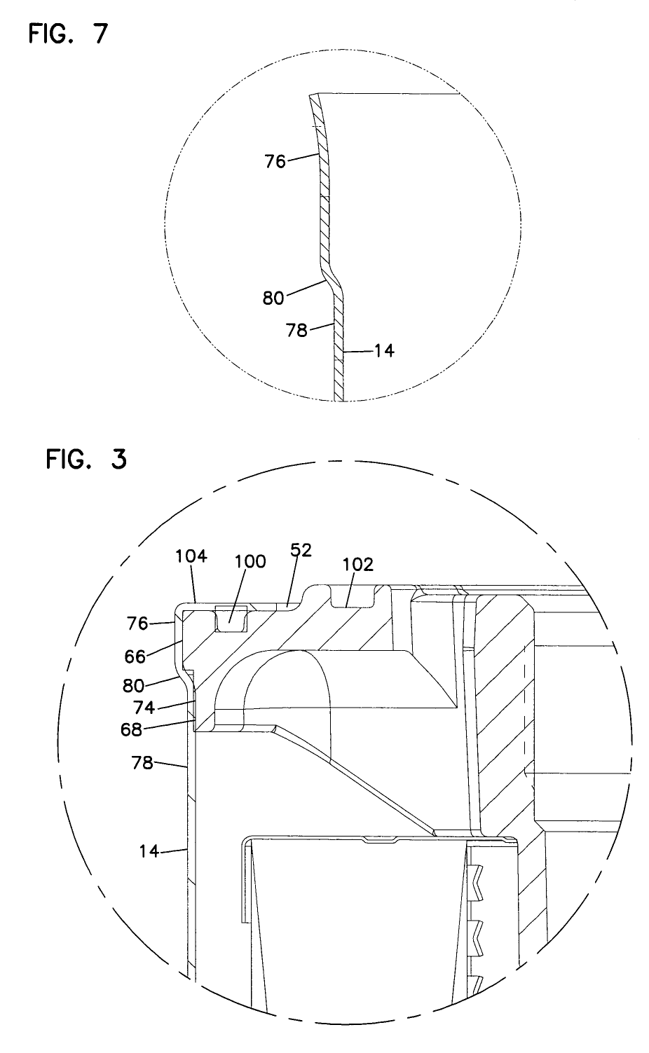

In reference now to FIG. 3, a seal 74 is formed between the housing 14 and the baffle plate 52 resulting from an interference fit between the housing 14 and the second diameter portion 68. As can be seen in FIGS. 3 and 7, the filter housing 14 has at least first and second diameter regions 76, 78. In the embodiment shown, the first diameter region 76 is greater than the second diameter region 78. In the embodiment shown, the first diameter region 76 is radially adjacent to and pressed against the radial surface 56 of the baffle plate 52. In particular, in the embodiment shown, the first diameter region 76 is radially adjacent to the first diameter portion 66 of the baffle plate 52. The second diameter region 78 of the housing 14 is adjacent to the second diameter portion 68 of the baffle plate 52, in the embodiment shown. In preferred embodiments, the second diameter portion 68 of the baffle plate 52 has a larger diameter than the inside diameter of the second diameter region 78 of the housing 14 to result in an interference fit. This interference fit creates the seal 74 from metal to metal contact. Between the first diameter region 76 and second diameter region 78 is a kink or bend 80. The bend 80 forms a transition between the first diameter region 76 and second diameter region 78. The bend 80, in the embodiment shown, is not orthogonal.

In some embodiments, an adhesive or sealant can be used on the axial surface 72 (FIG. 5) of the step 70 and on the second diameter portion 68 to further help with the seal between the baffle plate 52 and the housing 14.

In preferred embodiments, the baffle plate 52 is die cast. Note also that the outer wall 58 does not have any grooves (i.e., it is “groove-free”) or any other seats for holding sealing gaskets therein. That is, the outer circumferential wall 58 is free of an independent sealing gasket.

In reference again to FIG. 2, the baffle plate 52 includes a hub 82, in particular, a centrally axially extending hub 82 that is interconnected by a plurality of radial webs or ribs 84 with a generally circular outer rim 86. The hub 82 defines a central opening 88, extending through the baffle plate 52 and terminating inside the filter element 12, in particular, inside the inner liner 48. Fluid passages 90 (FIG. 1) defined by the ribs 84 and the surrounding hub 82 allow liquid to flow therethrough and into the interior volume 32 of the filter housing 14.

Threads 92 are provided on the internal surface of the hub 82 for connecting the filter assembly 10 to the filter head 16. The hub 82 preferably extends below the ribs 84 and into the upper end of the filter element 12.

In the embodiment shown in FIG. 2, the filter element 12 is secured to the baffle plate 52 by direct connection or “potting” of the first end cap 40 to a neck 94 of the hub 82. This method of assembling a filter assembly is described further in commonly assigned U.S. Pat. No. 6,345,721, incorporated by reference herein.

In FIGS. 2 and 3, note that the first axial face 60 defines a groove 96. The groove 96 is a continuous circular groove recessed from the top end surface to form a seat 98. An optional sealing gasket 100 can be oriented within the seat 98 of the groove 96. This gasket 100 is optional, with the main, primary seal between the baffle plate 52 and the housing 14 occurring at the seal 74. If gasket 100 is used, a lathe-cut gasket can be used and be compressed between the baffle plate 52 and a folded portion 104 (FIG. 3) of the housing 14 to form a seal therebetween. The folded portion 104 extends orthogonally to the outer circumferential wall 56 and over the first axial face 60.

Before connection to the filter head 16, there is another sealing gasket (not shown) mounted within the baffle plate 52. In particular, the baffle plate 52 includes a second groove 102 to receive a sealing gasket therein. This sealing gasket forms a seal with the filter head 16.

D. Methods

In operation, the filter assembly 10 works as follows: in a forward-flow operation, fluid to be cleaned enters the filter head through inlet 22. From there, it flows through the openings or passages 90 in the baffle plate 52 and into the interior volume 32 of the housing 14. From there, the fluid is forced to flow through the filter media 46 and into the open interior volume 44 of the filter cartridge 12.

From the interior volume 44, the cleaned fluid passes through the central opening 88 of the baffle plate 52. The cleaned fluid then exits the filter assembly 10 and flows through the filter head 16 and out through the outlet 24.

After a period of operation, the filter media 46 will become occluded. The occluded filter media 46 will cause an increase in restriction. At such time, it will become appropriate to change and replace the filter assembly. In order to do this, the filter assembly 10 will be released from the filter head 16 by unscrewing the filter assembly 10 from the filter head 16. This will release a seal formed between the filter head 16 and the second groove 102 of the baffle plate 52. The old filter assembly 10 is discarded and replaced with a new filter assembly 10. The new filter assembly 10 is screwed onto the filter head 16 and filtering can then be restarted.

To assemble the filter assembly 10, housing 14 is provided. The filter element 12 and baffle plate 52 form an assembly and is mounted into the housing 14 through open end 34. Next, the baffle plate 52 is pressed into the housing 14 to create interference fit between the second diameter portion 68 and the housing 14, which forms a seal between the housing 14 and the baffle plate 52. Next, a portion 104 of the housing 14 is folded over a top or the first axial face 60 of the baffle plate 52.

E. Example Dimensions

The following are examples of useable dimensions for filter assemblies of the type characterized herein. One embodiment of the baffle plate 52 has a second diameter portion 68 having a diameter of about 4.5 inches, with the first diameter portion 66 having a dimension of about 4.59 inches. The axial length of the first diameter portion 66 is about 0.25 inch, while the axial length of the second diameter portion 68 is about 0.25 inch. The overall outside diameter of the fluid filter assembly 10 is about 4.66 inches, with the overall length being about 11.63 inches. The overall length of the filter cartridge 12 is about 10 inches.

In another implementation, the first diameter portion 66 has an outer diameter of about 3.73 inches, while the second diameter portion 68 has a diameter of about 3.65 inches. The axial length of the first diameter portion 66 is about 0.22 inch, with the axial length of the second diameter portion being about 0.22 inch. The outside diameter of the overall filter assembly 10 is about 3.82 inches, with the overall length of the filter assembly 10 being about 9.44 inches. The filter cartridge 12 has an overall length of about 8.03 inches.

What is claimed is:

1. A fluid filter assembly including:
(a) a housing having a wall defining an interior, a closed end, and an open end;
(b) a filter element operably oriented in the interior of the housing;
(c) a baffle plate mounted to operably cover said housing open end;
(i) the baffle plate including a first axial face with an exterior top end surface and an outer circumferential wall circumscribing the first axial face;
(ii) the outer circumferential wall being a groove-free outer radial surface;
(iii) the outer circumferential wall having a first diameter portion adjacent to the first axial face and a second diameter portion;
(A) the second diameter portion being remote from the first axial face;
(B) the second diameter portion having a diameter less than the first diameter portion; and
(d) a seal between the housing and the baffle plate resulting from an interference fit between the housing wall and the second diameter portion.

2. A fluid filter assembly according to claim 1 wherein:
(a) the baffle plate is die cast.

3. A fluid filter assembly according to claim 1 wherein:
(a) the outer circumferential wall is free of an independent sealing gasket.

4. A fluid filter assembly according to claim 1 wherein:
(a) the filter element includes a first, open end cap; a second, closed end cap; and an extension of pleated filter media secured to said first and second end caps;
(i) said extension of pleated filter media defining an open filter interior.

5. A fluid filter assembly according to claim 4 wherein:
(a) the baffle plate includes a hub defining a central opening therethrough; the hub extending through said first open end cap and into said open filter interior.

6. A fluid filter assembly according to claim 5 wherein:
(a) the hub has an internal surface defining threads to connect the filter assembly to a filter head.

7. A fluid filter assembly according to claim 5 wherein:
(a) said baffle plate further includes a plurality of radial ribs extending from said hub.

8. A fluid filter assembly according to claim 1 wherein:
(a) the housing includes a folded portion;
(i) the folded portion extending orthogonally to the outer circumferential wall of the baffle plate and over a portion of the first axial face.

9. A fluid filter assembly according to claim 8 further comprising:
(a) a sealing gasket between the folded portion and the first axial face.

10. A fluid filter assembly according to claim 1 further comprising:
(a) a sealant material located at the interference fit between the housing wall and the second diameter portion.

11. A fluid filter assembly according to claim 1 wherein:
(a) a difference between second diameter portion and the first diameter portion is at least 1.5%.

12. A fluid filter assembly according to claim 1 wherein:
(a) a difference between second diameter portion and the first diameter portion is not greater than 5%.

13. A filter arrangement comprising:
(a) a fluid filter assembly including a housing having a wall defining an interior, a closed end, and an open end; a filter element operably oriented in the interior of the housing; a baffle plate mounted to operably cover said housing open end;
(i) the baffle plate including a first axial face with an exterior top end surface and an outer circumferential wall circumscribing the first axial face;
(ii) the outer circumferential wall being a groove-free outer radial surface;
(iii) the outer circumferential wall having a first diameter portion adjacent to the first axial face and a second diameter portion;
(A) the second diameter portion being remote from the first axial face;
(B) the second diameter portion having a diameter less than the first diameter portion;
(iv) a seal between the housing and the baffle plate resulting from an interference fit between the housing wall and the second diameter portion; and
(b) a filter head; the filter assembly being operably removably mounted on the filter head.

14. A filter arrangement according to claim 13 wherein:
(a) the filter assembly is mounted to the filter head with a threaded connection.

15. A filter arrangement according to claim 13 wherein:
(a) the baffle plate includes a hub defining a central opening therethrough; the hub having an internal surface defining threads to connect the filter assembly to the filter head.

16. A filter arrangement according to claim 13 wherein:
(a) the baffle plate is die cast; and
(b) the outer circumferential wall is free of an independent sealing gasket.

17. A method for constructing a fluid filter; the method comprising:
(a) providing a housing having a closed end and an open end;
(b) mounting a filter element and a baffle plate assembly into the housing through the open end; the filter element and baffle plate assembly including a baffle plate having an outer circumferential wall with a first diameter portion and a second diameter portion; the second diameter portion having a diameter less than the first diameter portion;
(c) pressing the baffle plate into the housing to create an interference fit between the second diameter portion and the housing; and
(d) folding a portion of the housing over a top of the baffle plate.

18. A method of installing a filter assembly comprising:
(a) spinning a filter assembly onto a filter head; the filter head being mounted on and in fluid communication with a fluid system of equipment; the filter assembly including:
(i) a housing having a closed end and an open end;
(ii) a filter element operably oriented in the housing;
(iii) a baffle plate mounted to operably cover the housing open end; the baffle plate including a first axial face and an outer circumferential wall circumscribing the first axial face;
(A) the outer circumferential wall being a groove-free outer radial surface;
(iv) the outer circumferential wall having a first diameter portion adjacent to the first axial face and a second diameter portion;
(A) the second diameter portion being remote from the first axial face;
(B) the second diameter portion having a diameter less than the first diameter portion; and
(v) a seal between the housing and the baffle plate resulting from an interference fit between the housing wall and the second diameter portion.
